(19) United States
(12) Patent Application Publication
(10) Pub. No.: US 2026/0094048 A1
(43) Pub. Date: Apr. 2, 2026

(54) MACHINE LEARNING MODEL PRUNING SYSTEM

(71) Applicant: Amazon Technologies, Inc., Seattle, WA (US)

(72) Inventors: Gilad Amir Rosenberg, Vancouver (CA); John Kyle Brubaker, San Diego, CA (US); Martin Schuetz, Brooklyn, NY (US); Helmut Gottfried Katzgraber, Kirkland, WA (US)

(73) Assignee: Amazon Technologies, Inc., Seattle, WA (US)

(21) Appl. No.: 18/899,369

(22) Filed: Sep. 27, 2024

(51) Int. Cl. G06N 20/00

(52) U.S. Cl. CPC G06N 20/00

(57) ABSTRACT

Methods and apparatus for pruning weights of a trained machine learning model and making pruning adjustments to substantially optimize a loss function. In some embodiments, a machine learning model pruning system is configured to perform a first pruning pass of a machine learning model wherein at least a portion of the weights are set to zero. In some embodiments one or more additional pruning passes of the machine learning model may be performed in batches wherein each batch comprises one or more remaining weights and one or more previously pruned weights. In some embodiments, one or more pruning adjustments may be determined based on an optimization problem that minimizes a loss function for a given batch. In some embodiments, the pruning adjustment comprises restoring a previously pruned weight or pruning a remaining weight of the model.

### BACKGROUND

Machine learning models can take input data and infer meaningful output for many different applications (e.g., perform inferences). Training machine learning models includes the use of model training data and adjusting parameters of the machine learning model to improve a loss function (e.g., to train the model). For example, a lower loss function output value indicates a model output is closer to an accepted (e.g. known) value of the training data. Some machine learning models, such as large language models, amongst others, may include a large number of parameters. Thus, even once trained, the machine learning models may be costly to store and use for inference due to their large size.

### BRIEF DESCRIPTION OF THE DRAWINGS

FIG. 1 is a high-level diagram illustrating a machine learning (ML) model pruning system, wherein the ML model pruning system performs a first pruning pass and one or more additional pruning passes to prune an ML model, according to some embodiments.

FIG. 2A is a high-level diagram illustrating an example of a machine learning model with a plurality of weights and corresponding weight-scoring metrics that may be used by a ML model pruning system to prune the machine learning model, according to some embodiments.

FIG. 2B is a high-level diagram illustrating a first pruning pass for a machine learning model, wherein an ML model pruning system prunes weights of the machine learning model based on a weight-scoring metric, one or more weight-scoring thresholds, or a target density of weights, according to some embodiments.

FIG. 2C is a high-level diagram illustrating an additional pruning pass for a machine learning model, wherein the ML model pruning system performs additional pruning adjustments, the additional pruning adjustments comprising restoring a previously pruned weight or pruning a remaining weight of the ML model, wherein these additional pruning adjustments are performed for a given first batch of weights, according to some embodiments.

FIG. 2D is a high-level diagram illustrating an additional pruning pass for a machine learning model, wherein the ML model pruning system performs more pruning adjustments, comprising restoring a previously pruned weight or pruning a remaining weight of the ML model, for a given second batch of weights, according to some embodiments.

FIG. 2E is a high-level diagram illustrating an additional pruning pass for a machine learning model, wherein the ML model pruning system performs another round of pruning adjustments, comprising restoring a previously pruned weight or pruning a remaining weight of the ML model, for a given third batch of weights, according to some embodiments.

FIG. 2F is a high-level diagram illustrating an example of a pruned machine learning model, according to some embodiments.

FIG. 3 is a high-level diagram illustrating a machine learning model pruning system receiving a machine learning model and outputting a pruned machine learning model, wherein the machine learning model has a plurality of layers and a plurality of nodes for each layer, and wherein weights for edges between at least some of the nodes are pruned from the machine learning model to generate the pruned machine learning model, according to some embodiments.

FIG. 4 is a diagram illustrating a machine learning model pruning system and an optimization problem service, wherein a computing device, such as a quantum hardware device, is employed to solve an optimization problem used to determine weights to be pruned from a machine learning model by the machine learning model pruning system, according to some embodiments.

FIG. 5 is a flowchart describing an example process used by a machine learning model pruning system to perform a first pruning pass of a machine learning model and an additional pruning pass of the machine learning model, according to some embodiments.

FIG. 6 is a flowchart describing an example process of a machine learning model pruning system, wherein a plurality of epochs and a plurality of steps in respective epochs are performed, according to some embodiments.

FIG. 7 is a flowchart describing an example process of a machine learning model pruning system for optimizing pruning adjustments using an optimization problem, according to some embodiments.

FIG. 8 is a block diagram illustrating an example quantum hardware device that may be configured to execute quantum algorithms used in determining weight pruning choices, according to some embodiments.

FIG. 9 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, a system, and/or an apparatus for performing iterative pruning of machine learning models. For example, a machine learning (ML) model may include a vast number of parameters. Examples of machine learning models that may be pruned include, but are not limited to, neural networks and deep learning models. Having more parameters may increase the processing time and computational effort needed to use the ML model for inferencing. In some embodiments, a machine learning model pruning system may be used to compress a trained machine learning model. For example, a machine learning model pruning system may prune (e.g., set to zero, or remove) a number of weights of the model. Furthermore, one or more additional pruning passes of the machine learning model may be performed by the ML model pruning system, including pruning adjustments for a given batch of weights of the model. For example, pruning adjustment may comprise restoring a previously pruned weight or pruning a remaining weight (e.g., pruning a weight that was not previously pruned). In some embodiments, a machine learning model pruning system may use an optimization problem to determine one or more pruning adjustments to be made for a given batch of model weights that minimizes an expected change of a loss function. In some embodiments, a weight-scoring metric may be assigned to respective weights of the machine learning model. Thus, during a first pruning pass, respective weights with a weight-scoring metric below a threshold may be pruned by the machine learning model pruning system while respective weights with a weight-scoring metric above a threshold may be kept. In some embodiments, the first pruning pass of the machine learning model sets some weight values to zero to reduce the number of weights used in the model to a target density, wherein the target density corresponds to a ratio of the number of weights with a non-zero value after pruning to the total number of weights before pruning.

In some embodiments, the machine learning model pruning system may perform additional pruning passes over batches of weights of the machine learning model (e.g., not all the weights of the model are in the same pruning pass). In some embodiments, the pruning adjustments for a given batch of the one or more additional pruning passes maintains a ratio of a number of weights after the pruning adjustment and a number of weights before the pruning adjustment within a tolerated range (e.g., the target density is substantially maintained). In some embodiments, the machine learning model pruning system may exempt weights from consideration for pruning adjustments in subsequent passes (after the first pass) based on the exempted weights having a determined predicted significance (e.g., weight-scoring metric value) greater than a threshold, having the determined predicted significance less than another threshold, or having been considered for pruning adjustment in a previous batch of a given layer of the machine learning model. This may promote exploration of new weight pruning adjustments. Also, note that since weights are pruned based on weighting in the first pass, highly weighted weights are also likely to not be pruned in the first pass.

In some embodiments, a trained machine learning model may undergo adjustments to improve performance (e.g., inference accuracy, computing resources needed, etc.). For example, the machine learning model may be pruned to reduce the number of weights used by the model to make inferences. In such cases, an initial pruning may reduce the number of weights to a target density, wherein a validation accuracy of the pruned model as compared to the original not pruned model may be considered throughout the pruning process. With the pruned machine learning model having fewer weights, adjustments to which weights are kept and which weights are pruned may be considered. For example, an optimization algorithm may be implemented to calculate an expected change in a loss function and substantially optimize pruning adjustments to minimize the change in the loss function. There may be a range of solutions that substantially optimize pruning adjustments. For example, an approximate global or approximate local optimization may be obtained. In such an embodiment, weights that were pruned initially may be adjusted to be un-pruned (e.g., reinstated) and weights that were initially kept may be pruned. This pruning adjustment may be implemented iteratively on batches of weights. Batch sizes may be determined by a fixed number of weights or may vary from batch to batch. Once enough batches of weights are adjusted, the model may be reevaluated for validation accuracy using labeled training data, for example. The process of adjusting the machine learning model in batches may be repeated to iteratively adjust the machine learning model. In some embodiments, iteratively adjusting which weights are pruned may be performed until a desired validation accuracy is achieved.

In some embodiments, an example method a machine learning model pruning system may use for pruning a machine learning model may be described such as by the following steps. The ML model pruning system may prune a machine learning model to a desired density of weights based on a weight-scoring metric calculated for respective weights. The ML model pruning system may fix weights to stay pruned if pruned or stay kept (e.g., not pruned) if not pruned based on values of the weight-scoring metric of respective weights being greater than a threshold amount or less than another threshold amount. For example, the ML model pruning system may maintain weights as pruned that correspond to small weight-scoring values, and maintain weights as kept (e.g., not pruned) that correspond to large weight-scoring values. Then, for each epoch in a determined number of epochs and for each step of an epoch and batch of data X, labels y, and randomly chosen layer of the machine learning model, the ML model pruning system may do the following. The ML model pruning system may select n candidate weights based on a selection method and a list of previously considered weights. The ML model pruning system may estimate gradients of a loss function. The ML model pruning system may estimate a Hessian of the loss function for the elements needed. The ML model pruning system may construct a per-block (e.g., per-batch) optimization problem. The ML model pruning system (or another optimization problem solving service) may solve the optimization problem to choose k weights to prune out of n. The ML model pruning system may apply the solution of the optimization problem of the block to the weights of the block (e.g., prune weights and un-prune weights as needed). The ML model pruning system may add the selected weights to a list of previously considered list for the layer. Once respective layers and respective blocks are iterated through, the ML model pruning system may calculate the loss and/or accuracy on the validation data for that epoch. In some embodiments, an epoch may be a fixed number of steps or a fixed number of batches.

In some embodiments, a machine learning model may be implemented on one or more computing devices. In general, visible nodes of a machine learning model may be provided input data for use in determining an inference result, wherein the inference result is determined based on values of weights, biases and activations of nodes of the machine learning model. A model may be trained using training data, wherein the values of weights and biases may be determined to minimize a loss function. However, when weights are selectively pruned, for example using a machine learning model pruning system as discussed herein, similar model performance may be achieved with fewer weights. For example, a much lighter-weight model may result from pruning, wherein inference results provided by the lighter-weight model differ from those of the full model by less than a threshold amount, wherein the threshold is an acceptable loss of accuracy, if any, that is outweighed by the benefits of a lighter-weight ML model.

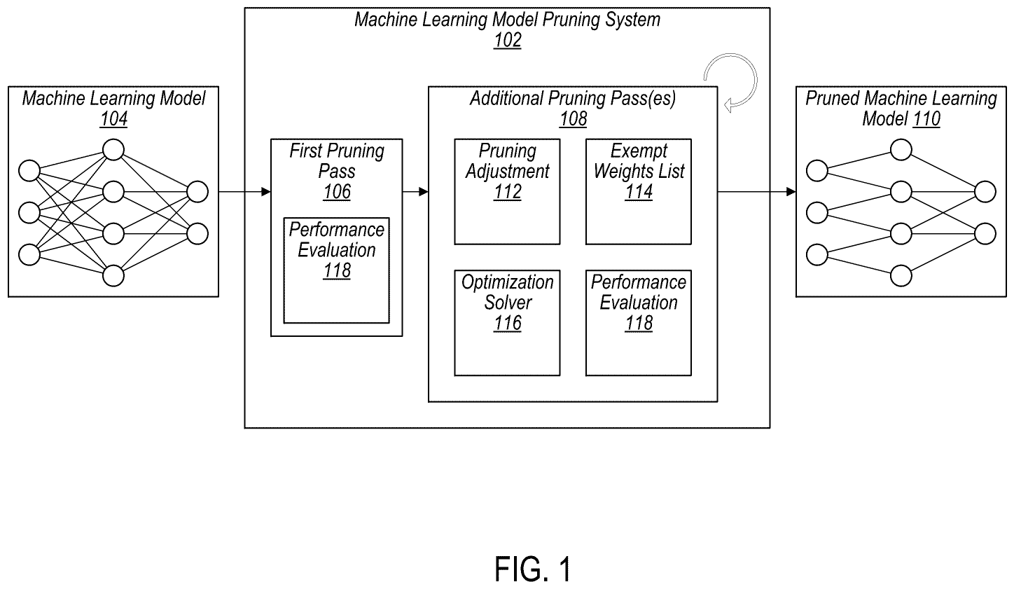

FIG. 1 is a high-level diagram illustrating a machine learning (ML) model pruning system, wherein the ML model pruning system performs a first pruning pass and one or more additional pruning passes to prune an ML model, according to some embodiments.

In some embodiments, machine learning model pruning system 102 may receive machine learning model 104, wherein a first pruning pass 106 makes an initial pruning of machine learning model 104 and performs a performance evaluation 118. For example, performance evaluation 118 may determine the validation accuracy of the adjusted machine learning model (e.g., loss and accuracy may be calculated using validation data). In some embodiments, a customer may provide a machine learning model to be compressed by the machine learning model pruning system. Then, one or more additional pruning passes 108 may cause adjustments to be made about which weights remain pruned, which weights are adjusted from pruned to not pruned, which weights are adjusted from not pruned to pruned, and which weights remain not pruned (e.g., kept). In some embodiments, machine learning model 102 may be assigned a weight-scoring metric or value to respective weights of the machine learning model, wherein the weight-scoring values are used to help determine if a weight is to be kept, pruned, or adjusted. Weight-scoring metrics may be determined via a plurality of methods. For example, weight-scoring values may be assigned randomly to each weight. In other examples, weight-scoring values may be assigned according to a magnitude of a weight, a magnitude of a product of weight value and the gradient of the weight, or a magnitude of a product of the weight value and the activation squared of a node that corresponds to the weight.

In some embodiments, the result of implementing the machine learning model pruning system 102 may be pruned machine learning model 110, wherein machine learning model 110 is based on a compression of machine learning model 104. Machine learning model 104 and pruned machine learning model 110 are high level examples of machine learning models. Other machine learning models may be used that have more or fewer neurons (e.g., represented by circles in FIG. 1). and/or more or fewer weights (e.g., represented by lines connecting circles in FIG. 1). Machine learning model 104 may additionally be a machine learning model that was previously pruned or otherwise adjusted, modified, or compressed (e.g., quantization of weight values) to, for example, improve performance of the machine learning model. Machine learning model pruning system 102 may initially prune machine learning model 104 based on a target density, wherein the target density corresponds to a target ratio of a number of weights of the machine learning model after the machine learning model is pruned (e.g., pruned machine learning model 110), and a number of weights of the machine learning model before the machine learning model is pruned (e.g., machine learning model 104). For example, machine learning model 104 comprises twenty weights, and the target density may be 0.6. Thus, machine learning model may be reduced by pruning (e.g., setting to zero) eight weights resulting in pruned machine learning model comprising twelve weights (e.g., the density is 12/20 or 0.6 like the target density).

In some embodiments, additional pruning passes 108 may not significantly change the density of weights (e.g., the reduced machine learning model will maintain about twelve weights after first pruning pass 106 and throughout additional pruning pass(es) 108). Additional pruning pass(es) 108 may comprise pruning adjustment 112, exempt weights list 114, optimization solver 116, and performance evaluation 118. For example, pruning adjustment 112 may comprise one or more computing devices configured to restore a previously pruned weight or pruning a remaining weight of the model. Weights that have been considered for pruning adjustment may be indicated on exempt weights list 114. In such an embodiment, a selection of n weights of a block (e.g., batch) may be selected for pruning adjustment, wherein the selected n weights of the block may be substantially optimized for pruning or un-pruning and added to exempt weights list 114. Exempted weights list 114 may have a maximum size wherein weights may be cycled through the exempted weights list 114 (e.g., weights may be replaced in a first in first out basis). Some conditions that enable a weight to be exempted from consideration may include having a determined predicted significance (e.g., weight-scoring metric value) greater than a threshold, having the determined predicted significance less than another threshold, or having been considered for pruning adjustment in a previous batch of a given layer of the machine learning model. An epoch of pruning adjustments may iterate over batches of weights and add considered weights to exempt weights list 114, wherein performance evaluation 118 may determine the validation accuracy of the adjusted machine learning model (e.g., loss and accuracy may be calculated using validation data). Thus, exempted weights list may be emptied and another epoch of substantially optimizing and adjusting weights may proceed. In some embodiments, each and every weight of the model may not necessarily be assessed for pruning adjustment.

In some embodiments, optimization solver 116 may comprise one or more computing devices configured to provide an optimization problem to an optimization problem service and receive results of the optimization problem from the optimization problem service. In other embodiments, optimization solver 116 may substantially solve the optimization problem.

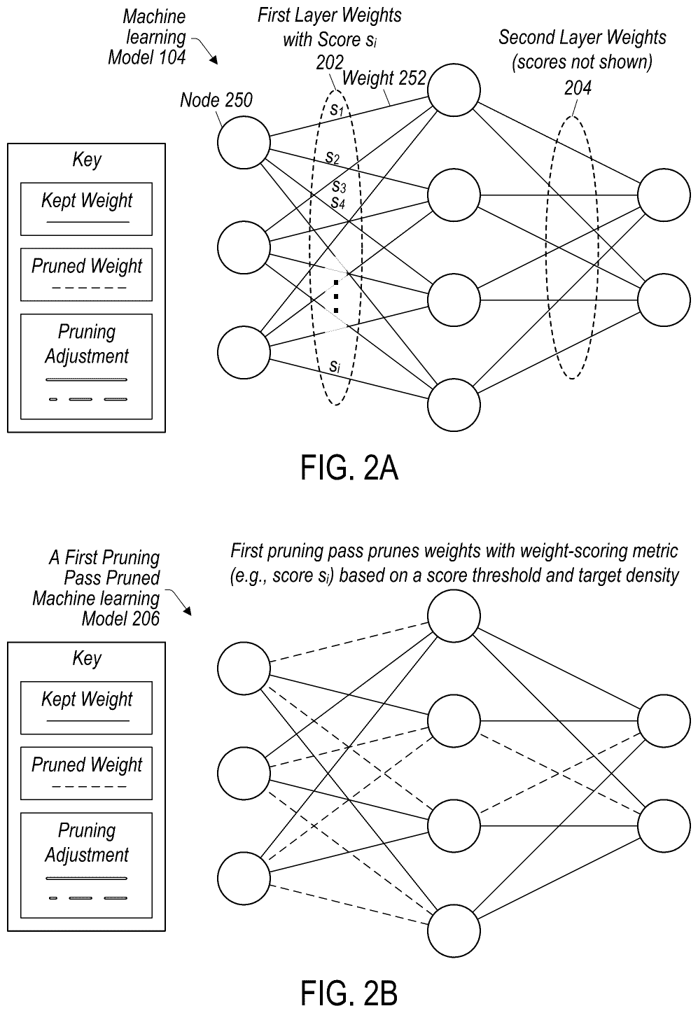

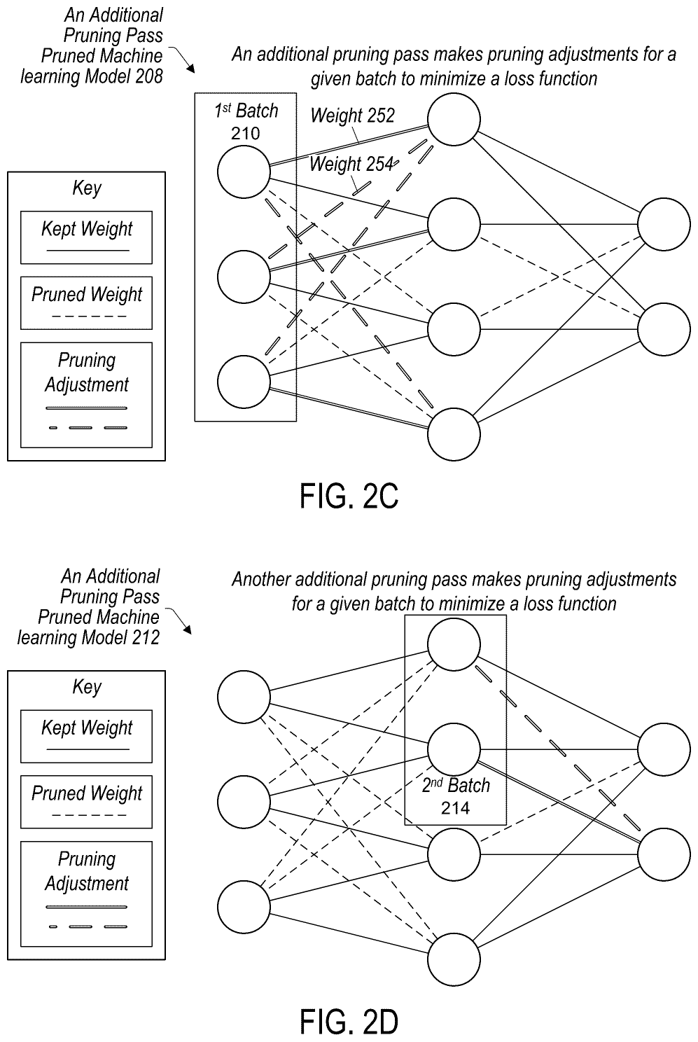

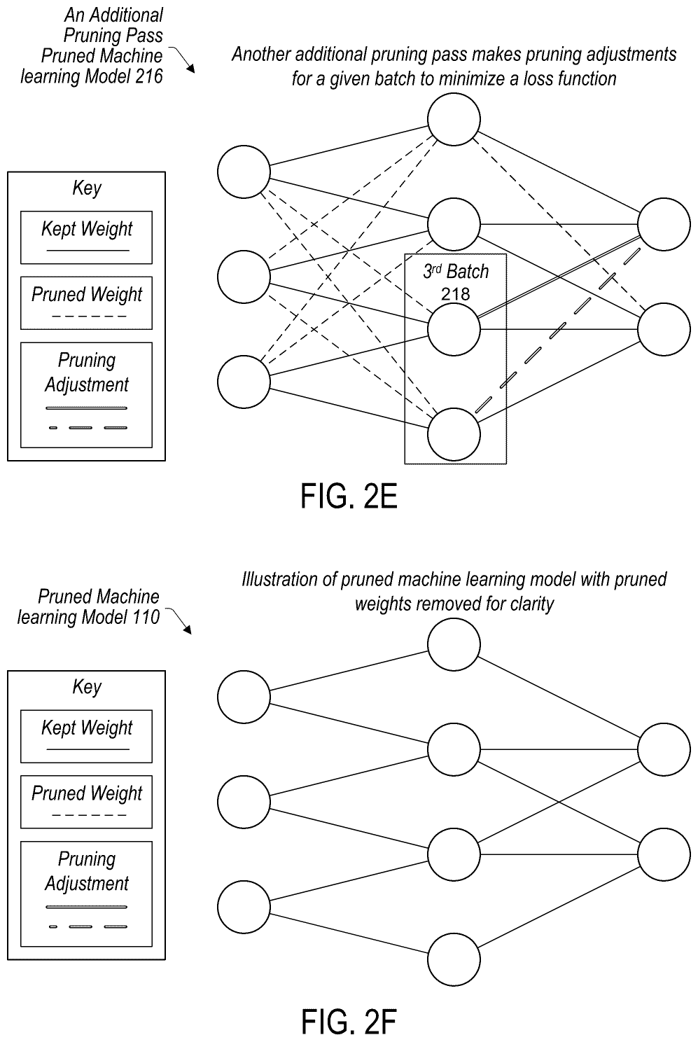

FIG. 2A is a high-level diagram illustrating an example of a machine learning model with a plurality of weights and corresponding weight-scoring metrics that may be used by a ML model pruning system to prune the machine learning model, according to some embodiments.

In some embodiments, such as shown in FIG. 2A, machine learning model 104 may comprise nodes (e.g., node 250) and weights (e.g., weight 252). A first layer of nodes (e.g., neurons) may comprise weights of the first layer with score sᵢ 202 (e.g., scores s₁ through sᵢ). In some embodiments, there may be weights for a plurality of different layers (e.g., second layer weights 204). Respective scores may be determined via several different methods. In some embodiments, machine learning model 102 may assign a weight-scoring metric (e.g., value) to respective weights of the machine learning model, wherein the weight-scoring values are used to help determine if a weight is to be kept, pruned or adjusted. In some embodiments, weight scoring values may represent one-shot metric-based method of assigning a score (e.g., value) to each weight. Weight-scoring metrics may be determined via a plurality of methods. For example, weight-scoring values may be assigned randomly to each weight. In other examples, weight-scoring values may be assigned according to a magnitude of a weight, a magnitude of a product of weight value and the gradient of the weight, or a magnitude of a product of the weight value and the activation squared of a node that corresponds to the weight. Weight values, weight-scoring values, and activation values of nodes may be stored in one or more computing resources.

FIG. 2B is a high-level diagram illustrating a first pruning pass for a machine learning model, wherein an ML model pruning system prunes weights of the machine learning model based on a weight-scoring metric, one or more weight-scoring thresholds, or a target density of weights, according to some embodiments.

In some embodiments, a machine learning model such as machine learning model 104 of FIG. 1 or FIG. 2A may undergo a first pruning pass. For example, first pruning pass 106 may prune a number of weights corresponding to a target density. For example, eight weights out of twenty weights are pruned (indicated by dashed lines), wherein the target density is about 0.6. In some embodiments, weights may be pruned by setting the value of that weight to zero. Weights may be pruned based on the weight-scoring values and one or more thresholds. For example, the machine learning model pruning system may be configured to assign a weight-scoring metric to each weight of the machine learning model and prune respective weights with a weight-scoring metric (e.g., value) below a threshold. An example of an output of the first pruning pass 106 may be pruned machine learning model 206. For example, in FIG. 2B, eight weights have been determined to comprise weight-scoring values below a threshold, wherein the weights are pruned.

In some embodiments, weights with a weight-scoring value above a large threshold may be fixed to be kept (e.g., not pruned), wherein the weights are not considered for pruning adjustment. Similarly, weights with a weight-scoring value below a small threshold may be fixed to be pruned, wherein the weights are not considered for pruning adjustment. Other weights may be considered for pruning adjustment, wherein reassignment of pruning or not pruning may substantially optimize a loss function.

FIG. 2C is a high-level diagram illustrating an additional pruning pass for a machine learning model, wherein the ML model pruning system performs additional pruning adjustments, the additional pruning adjustments comprising restoring a previously pruned weight or pruning a remaining weight of the ML model, wherein these additional pruning adjustments are performed for a given first batch of weights, according to some embodiments.

In some embodiments, a machine learning model may undergo one or more additional pruning passes 108. The one or more additional pruning passes 108 may make pruning adjustments for a given batch to minimize an expected change of a loss function, wherein the one or more additional pruning passes may maintain a ratio of a number of weights after the pruning adjustment and a number of weights before the pruning adjustment (e.g., target density) within a tolerated range. For example, a machine learning model such as a first pruning pass pruned machine learning model 206 may undergo pruning adjustments wherein a machine learning model such as additional pruning pass pruned machine learning model 208 results. Pruned machine learning model 208 illustrates weights that were pruned previously and now not pruned via an emphasized solid line (e.g., newly un-pruned or reinstated weight 252), and weights that where not pruned previously and now are pruned via an emphasized dashed line (e.g., newly pruned weight 254). For example, three nodes of the first layer comprise first batch 210. Other weights may be maintained as pruned or not pruned (e.g., kept). FIGS. 2C through 2F show weights to be associated with a subset of neurons (e.g., nodes). In some embodiments, a batch may comprise weights from a variety of non-adjacent neurons. Furthermore, each weight associated with a given neuron may or may not be included in a given batch. Weights may also be randomly selected from a given layer for a batch.

In some embodiments, to select which weights to reinstate (e.g., weight 252) and which weights to newly prune (e.g., weight 254), an optimization algorithm may be used.

FIG. 2D is a high-level diagram illustrating an additional pruning pass for a machine learning model, wherein the ML model pruning system performs more pruning adjustments, comprising restoring a previously pruned weight or pruning a remaining weight of the ML model, for a given second batch of weights, according to some embodiments.

In some embodiments, a batch may comprise a fraction of the weights included in a given layer of a machine learning model. For example, pruned machine learning model 208 may undergo another step for an additional pruning pass performed by the ML model pruning system, wherein weights of second batch 214 are pruned to result in the additional pruning pass pruned machine learning model 212. In such an embodiment, the new batch of weights are substantially optimized based on estimated gradient terms and estimated Hessian terms, estimated by the ML model pruning system, corresponding to the batch. In some embodiments, the gradient terms may indicate a first derivative of a loss function with respect to weight values, and the Hessian may indicate a second derivative of a loss function with respect to weight values. In some embodiments, the estimated Hessian may be based on the per sample gradients.

FIG. 2E is a high-level diagram illustrating an additional pruning pass for a machine learning model, wherein the ML model pruning system performs another round of pruning adjustments, comprising restoring a previously pruned weight or pruning a remaining weight of the ML model, for a given third batch of weights, according to some embodiments.

In some embodiments, more additional pruning passes may be performed by the ML model pruning system until each weight has been considered and/or added to the exempt weights list (e.g., list 114). For example, another additional pruning pass may select a batch of weights (e.g., third batch 218), wherein pruning may be adjusted as needed. By way of further example, pruned machine learning model 212 may undergo an additional pruning pass, performed by the ML model pruning system, wherein pruned machine learning model 216 may result. Pruned machine learning model 216 may represent a machine learning model that underwent machine learning model pruning system 102, wherein weights were pruned and pruning adjustments were made. Pruned machine learning model 216 may undergo several epochs of pruning adjustments, wherein each epoch may comprise adjusting layers of weights in batches until each weight has been considered. Additional epochs may improve the validation accuracy of the pruned machine learning model.

FIG. 2F is a high-level diagram illustrating an example of a pruned machine learning model, according to some embodiments.

In some embodiments, the result of pruning a machine learning model (e.g., 104) using a machine learning model pruning system (e.g., 102) such as described herein may result in a pruned and substantially optimized machine learning model (e.g., 110).

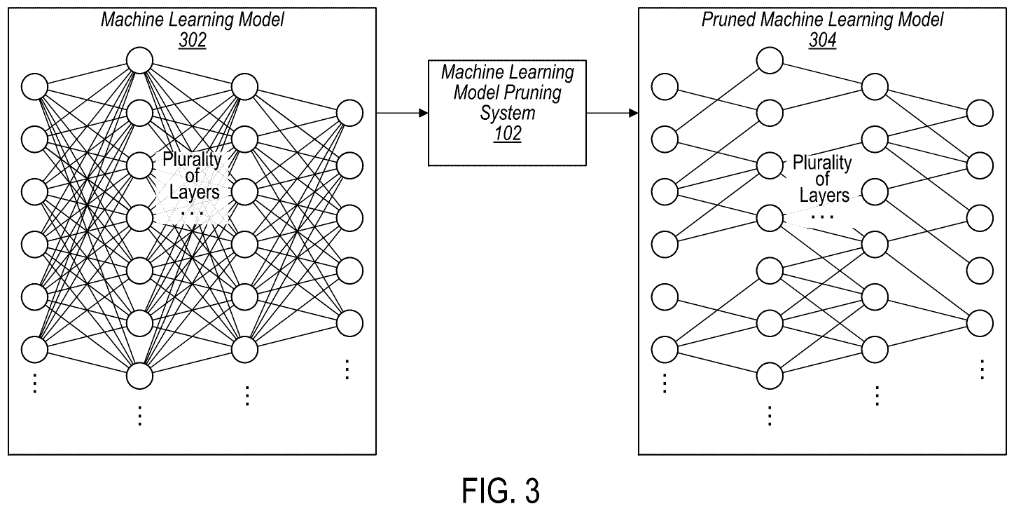

FIG. 3 is a high-level diagram illustrating a machine learning model pruning system receiving a machine learning model and outputting a pruned machine learning model, wherein the machine learning model has a plurality of layers and a plurality of nodes for each layer, and wherein weights for edges between at least some of the nodes are pruned from the machine learning model to generate the pruned machine learning model, according to some embodiments.

In some embodiments, machine learning model pruning system 102 may prune and substantially optimize large machine learning models such as machine learning model 302. For example, machine learning model 302 comprises a large plurality of layers and a large plurality of nodes and weights within each layer. In some embodiments, it may be impractical or not desired to solve an optimization problem for an entire layer of nodes. Thus, pruning adjustments may be iteratively done for respective weights in a given layer. For example, machine learning model pruning system 102 may prune and substantially optimize machine learning model 302 to result in compressed pruned machine learning model 304.

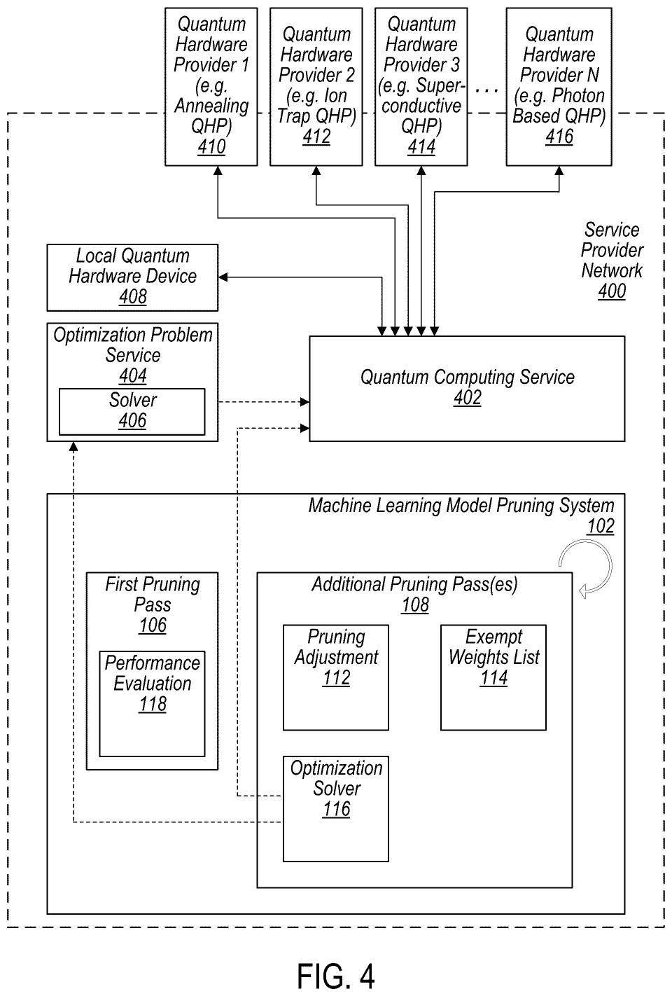

FIG. 4 is a diagram illustrating a machine learning model pruning system and an optimization problem service, wherein a computing device, such as a quantum hardware device, is employed to substantially solve an optimization problem used to determine weights to be pruned from a machine learning model by the machine learning model pruning system, according to some embodiments.

In some embodiments, machine learning model pruning system 102 may determine and substantially solve optimization problems via optimization solver 116 to substantially optimize pruning adjustments. Optimization of pruning adjustments may be based on gradient terms of a loss function, wherein an expected change in value of the loss function is minimized. Thus, some weights that were initially pruned may be unpruned and some weights that were not pruned may be pruned based on the gradient terms to minimize the expected change of the loss function.

In some embodiments, optimization solver 116 may determine an optimization problem to be solved and prepare the problem to be solved using a quantum computing service 402.

In some embodiments, optimization solver 116 may provide the optimization problem to the optimization problem service 404 and receive results of the optimization problem from the optimization problem service 404. In some embodiments, after optimization problem service 404 receives the optimization problem, the optimization problem service 404 may substantially solve the optimization on a classical computer. In some embodiments, solver 406 may be a binary integer program style program. In some embodiments, optimization problem service 404 may prepare the optimization problem to be solved using quantum computers. In such an embodiment, the optimization problem is solved using one or more quantum algorithms executed on the one or more quantum computing devices.

In some embodiments, service provider network 400 may include various services such as quantum computing service 402, machine learning model pruning system 102, and optimization problem service 404, in addition to one or more other services that pertain to quantum compilation and computation. In some embodiments, service provider network 400 may include data centers, routers, networking devices, etc., such as of a cloud computing provider network. In some embodiments, customers of service provider network 400 and/or quantum computing service 402, may be connected to the service provider network 400 in various ways, such as via a logically isolated connection over a public network, via a dedicated private physical connection, not accessible to the public, via a public Internet connection, etc.

In some embodiments, service provider network may include a compilation service. The compilation service may orchestrate one or more intermediate compilations (e.g., a compilation mapping of a logical quantum circuit to a given quantum hardware device structure, a compilation of gate nativization(s), translation of a quantum circuit into a quantum circuit specific to a given quantum hardware provider's design/language/architecture/technology, etc.) that may be used in order to take an input logical quantum circuit and conduct the execution of said circuit using a given quantum hardware device of a given quantum hardware provider.

In some embodiments, quantum computing service 402 may be configured to translate a given quantum computing object into a selected quantum circuit format for a particular quantum computing technology used by the selected quantum hardware provider or internal QPU, wherein the selected quantum circuit format for the particular quantum computing technology is one of a plurality of quantum circuit formats for a plurality of different quantum computing technologies supported by the quantum computing service. To translate the quantum computing object into the selected quantum circuit format, the one or more computing devices that implement the quantum computing service are configured to identify portions of the quantum computing object corresponding to quantum operators in an intermediate representation, substitute the quantum operators of the intermediate representation with quantum operators of the quantum circuit format of the particular quantum computing technology, and perform one or more optimizations to reduce an overall number of quantum operators in a translated quantum circuit that is a translated version of the received quantum computing object. Additionally, quantum computing service 102 may be configured to provide the translated quantum circuit for execution at a quantum hardware provider or internal QPU that uses the particular quantum computing technology; receive, from the quantum hardware provider or internal QPU, results of the execution of the translated quantum circuit; and provide a notification to a customer of the quantum computing service that the quantum computing object has been executed.

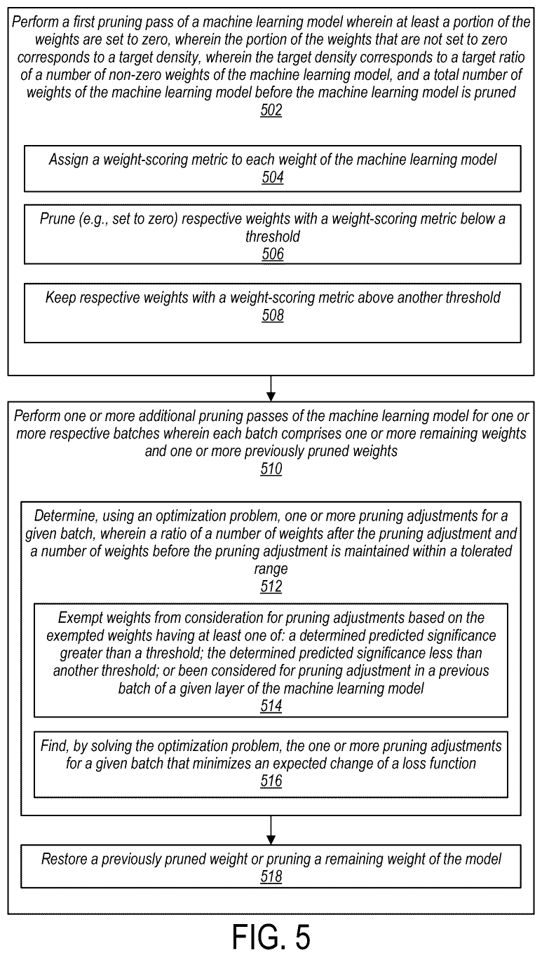

FIG. 5 is a flowchart describing an example process used by a machine learning model pruning system to perform a first pruning pass of a machine learning model and an additional pruning pass of the machine learning model, according to some embodiments.

At block 502, a first pruning pass 106 of a machine learning model 104 may be performed. To prune machine learning model 104, at least a portion of the weights are set to zero, wherein the portion of the weights that are not set to zero corresponds to a target density. The target density may correspond to a target ratio of a number of non-zero weights of the machine learning model, and a total number of weights of the machine learning model before the machine learning model is pruned. For example a user of the machine learning model pruning system 102 may provide information regarding a target density that a given machine learning model is to be pruned to.

At block 504 of block 502, the first pruning pass may include assigning a weight-scoring metric to each weight of the machine learning model 104. Weight-scoring values may be assigned randomly to each weight. In other examples, weight-scoring values may be assigned according to a magnitude of a weight, a magnitude of a product of weight value and the gradient of the weight, or a magnitude of a product of the weight value and the activation squared of a node that corresponds to the weight. Weight values, weight-scoring values, and activation values of nodes may be stored in one or more computing resources. In some embodiments, weight scoring values may be used to determine weights that are kept or pruned throughout each pruning pass such as the first pruning and additional pruning passes. For example, weights with high weight scoring values may be exempted from being pruned. Also, weights with very low weight scoring values may be exempted from being restored. These weights with high or low weight scoring values may be added to a list of fixed weights, wherein the fixed weights may not be eligible for pruning adjustments in one or more additional pruning passes.

At block 506 of block 502, respective weights may be pruned (e.g., the value of the weight is set to zero). This may be performed for weights with a weight scoring metric value below a threshold. For example, in some embodiments, all weights eligible for pruning (e.g. the non-exempt weights) may be ordered based on their respective weight scoring metric values and respective weights with a weight scoring value less than a threshold value may be pruned (e.g., have their weights set to zero in the first pruning pass). As a specific example, if a user specified a 50% target density, then a bottom approximate half of the weights may have their values set to zero when ordered according to the weight scoring value. However, note that in some embodiments, weights with high weight scoring values may be exempted from being pruned. Also, weights with very low weight scoring values may be exempted from being restored. Thus, when determining a number of weights to prune in a first pruning pass, the number of exempted weights may further be taken into account to assure the target density is achieved. Also, in some embodiments, the remaining weights subsequent to the first pruning pass may deviate from the target density as long as the target density is achieved via the subsequent additional pruning passes.

At block 508 of block 502, weights may be kept that have a weight scoring value above another threshold. In the additional pruning passes, weights that have been pruned or kept may be reassessed. In some embodiments, block 506 and block 508 may be performed concurrently. For example, weights that are not selected to be pruned may therefore be kept.

At block 510, one or more additional pruning passes 108 may be performed. For the first additional pruning passes 108, the initially pruned output from the first pruning pass 106 is used as input. Thus, some weights are set to zero and others are not set to zero. Subsequent additional pruning passes 108 may take the resulting ML model of the previous additional pruning pass as input.

At block 512 of block 510, pruning adjustments 112 are determined for the additional pruning passes 108. When determining pruning adjustments 112, a target number of non-zero weights is maintained within a tolerated range before and after pruning adjustments. This may keep the ML model at a desired target density throughout the additional pruning passes. However, as noted above, for each individual pass the resulting output may vary slightly from the target density as long as the resulting density at the end of the full set of passes achieves the target density.

At block 514 of block 512, weights may be added to an exempt weights list 114. Weights may be exempted from consideration for pruning adjustment based on a number of criteria. For example, weights that are exempted may include weights that have a determined predicted significance greater than a threshold or lower than another threshold, or weights that previously have been considered for pruning adjustment. In some embodiments, weights in the exempted weights list may be reconsidered after a tenure period. For example, exempt weights list 114 may have a fixed size, and weights that are on the list may be moved out of the list to be replaced by other weights. One example for using the exempt weight list is to promote exploration of weight pruning adjustments. While not shown, prior to performing the first pruning pass, weights that have a determined predicted significance greater than a threshold or lower than another threshold may have been added to the exempt list. Moreover, at block 514 additional weights that were considered in the current (or next) pruning pass may be added to the exempt list as previously considered weights.

At block 516 of block 512, an optimization problem is used to determine one or more pruning adjustments for a given batch that minimizes an expected change of a loss function. The expected change of the loss function may be determined by using estimated gradients or Hessians of samples.

At block 518 of block 510, the pruning adjustments are implemented. For example, a previously pruned weight may be restored (e.g., set to the original weight value) and/or a remaining weight of the model may be pruned (e.g., set to zero).

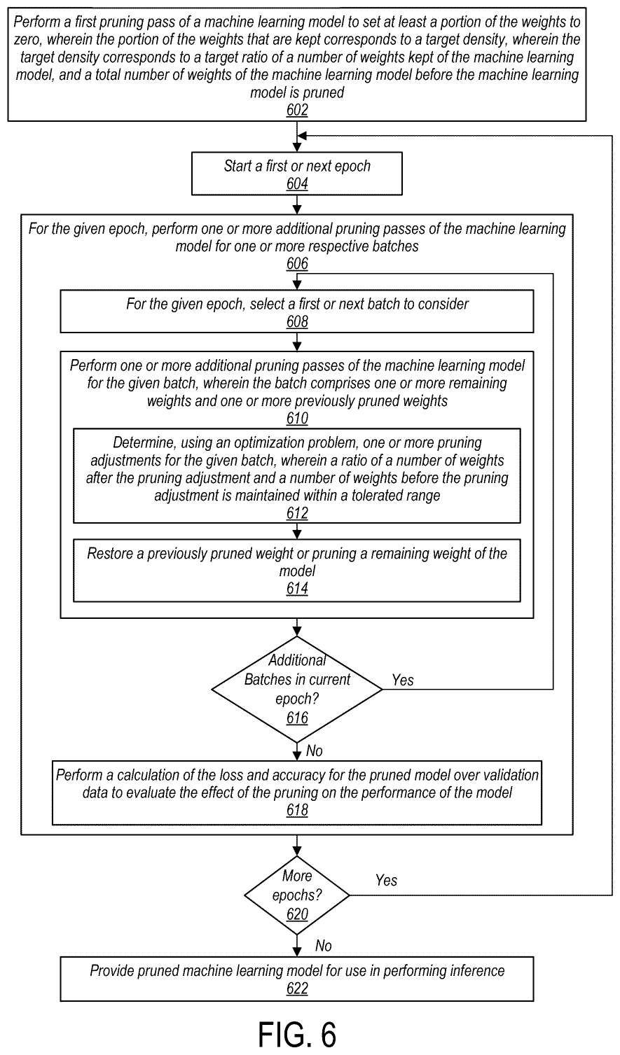

FIG. 6 is a flowchart describing an example process of a machine learning model pruning system, wherein a plurality of epochs and a plurality of steps in respective epochs are performed, according to some embodiments.

At block 602, a first pruning pass 106 of a machine learning model 104 may be performed. To prune machine learning model 104, at least a portion of the weights are set to zero, wherein the portion of the weights that are not set to zero corresponds to a target density. The target density may correspond to a target ratio of a number of non-zero weights of the machine learning model, and a total number of weights of the machine learning model before the machine learning model is pruned.

At block 604, a first epoch or next epoch is started. In some embodiments, an epoch may comprise iterating through weights of a machine learning model and adjusting pruning in cases that an expected change for a loss function may be minimized. Several epochs may be performed in order to further adjust weights of a model and may improve performance accuracy of the pruned and adjusted model.

At block 606, one or more epochs of additional pruning passes 108 may be used to iteratively adjust the pruning of a machine learning model. An epoch may comprise considering multiple batches of weights for pruning adjustments in order to adjust the machine learning model. Multiple epochs may also be used to iteratively update the machine learning model. Additional pruning passes 108 may take as input the output of first pruning pass 106.

At block 608, a first or next batch of weights is considered. For example, the machine learning model pruning system may select weights for consideration and after performing additional pruning passes, the machine learning model pruning system may select a next batch of weights to consider.

At block 610, the machine learning model pruning system performs one or more additional pruning passes of the machine learning model for the given batch, wherein the batch comprises one or more remaining weights and one or more previously pruned weights. For example, in some embodiments, the steps at block 610 may be similar to block 510 above.

At block 612, pruning adjustments for a given batch are determined. In some embodiments, an optimization problem is solved by one or more computing devices configured to solve optimization problems 116. The optimization problem may comprise finding a pruning adjustment for a given batch of weights that minimizes an expected change in a loss function. For example, in some embodiments, an optimization solver 116 of machine learning model pruning system may formulate an optimization problem to select pruning adjustments that minimize the change to the loss function. Where a change in the loss function represents a change (e.g. loss) in model accuracy as compared to the un-pruned machine learning model, and/or a change (e.g. loss) in model accuracy as compared to a partially pruned version of the machine learning model prior to implementation of an additional adjustment recommended by the optimization solver. In some embodiments, the optimization solver 116 may solve the optimization problem itself, or may submit an optimization problem formulated by the optimization solver 116 to an optimization problem service, such as optimization problem service 404 shown in FIG. 4. Also, in some embodiments, the optimization solver 116 may formulate the optimization problem as a quantum algorithm that can be submitted to a quantum computing service for execution, such as quantum computing service 402 (also shown in FIG. 4).

At block 614, the pruning adjustments are implemented. For example, a previously pruned weight may be restored (e.g., set to the original weight value) and/or a remaining weight of the model may be pruned (e.g., set to zero).

At block 616, it may be determined if a given epoch has been completed. For example, an epoch may have a determined number of steps or a determined number of batches of weights that are to be iterated through before the epoch is over. Wherein the epoch is not complete, the additional pruning pass advances to the next batch of weights or the next step of the epoch and more optimization problems may be solved. Wherein the epoch is complete, the machine learning model may be evaluated for accuracy.

At block 618, performance evaluation 118 is performed. For example, a loss function value for the pruned and adjusted model is calculated using validation data. The loss function value may be used to determine the effect of the pruning and adjustment on the performance of the model.

At block 620, it may be determined if there are more epochs to perform. Wherein there are more epochs, the process loops back to the start of block 604. Wherein there are no more epochs, the pruned and adjusted machine learning model is provided.

At block 622, the adjusted and pruned machine learning model is provided for use in performing inferences. For example, a user provided, trained machine learning model 104 may be pruned and adjusted according to machine learning model pruning system 102 such as described herein. Machine learning model pruning system 102 may be provided as a service to output a pruned and adjusted machine learning model to a customer/user.

In some embodiments, an optimization problem may be solved on a classical computer or a quantum computer.

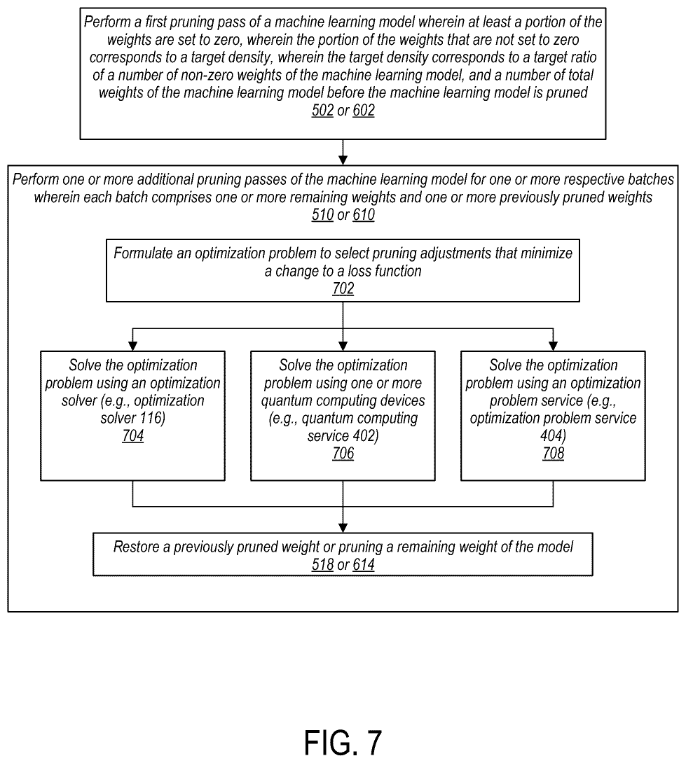

FIG. 7 is a flowchart describing an example process of a machine learning model pruning system for optimizing pruning adjustments using an optimization problem, according to some embodiments.

In some embodiments, a first pruning pass such as in block 502 or 602 may be performed. To perform one or more additional pruning passes such as at block 510 or 610, an optimization problem may be used. At block 702, the optimization problem is formulated. For example, in some embodiments, an optimization solver 116 of machine learning model pruning system 102 may formulate an optimization problem to select pruning adjustments that minimize the change to the loss function. Where a change in the loss function represents a change (e.g. loss) in model accuracy as compared to the un-pruned machine learning model, and/or a change (e.g. loss) in model accuracy as compared to a partially pruned version of the machine learning model prior to implementation of an additional adjustment recommended by the optimization solver. In some embodiments, gradients and Hessian may be used in formulating the optimization problem that is solved at block 704, 706, or 708. The optimization problem may be substantially solved in various ways such as described below.

At block 704, for example, the optimization problem determined at block 702 may be solved by the machine learning model pruning system. In some embodiments, the optimization solver 116 may solve the optimization problem itself.

At block 706, for example, the optimization problem determined at block 702 may be solved using one or more quantum computing devices. For example, in some embodiments, the optimization solver 116 may formulate the optimization problem as a quantum algorithm that can be submitted to a quantum computing service for execution, such as quantum computing service 402 (also shown in FIG. 4). The optimization solver may receive results from the quantum computing service.

At block 708, for example, the optimization problem determined at block 702 may be solved using an optimization problem service. For example, optimization solver 116 may submit an optimization problem formulated by the optimization solver 116 to an optimization problem service, such as optimization problem service 404 shown in FIG. 4. Once the optimization problem service substantially solves the optimization problem, the resulting recommended pruning adjustments may be obtained by optimization solver 116. Also, in some embodiments, an optimization problem service such as optimization problem service 404, may utilize a quantum computing service to solve the optimization problem. For example at block 706 the optimization solver 116 may interact with the quantum computing service to orchestrate execution of the optimization problem, and at block 708 the optimization solver 116 may interact with an optimization service to orchestrate execution of the optimization problem, wherein in some embodiments the optimization service may further coordinate with the quantum computing service to solve the optimization problem.

At block 518 or 614, such as described above, the machine learning model pruning system may restore a previously pruned weight or prune a remaining weight of the model according to pruning adjustments recommended by the solution to the optimization problem. Furthermore, performance evaluation 118 may be performed to evaluate the accuracy pruned and adjusted model according to test data.

In some embodiments, a method of a machine learning model pruning system may be utilized for a plurality of instances, wherein weights are iteratively pruned or un-pruned.

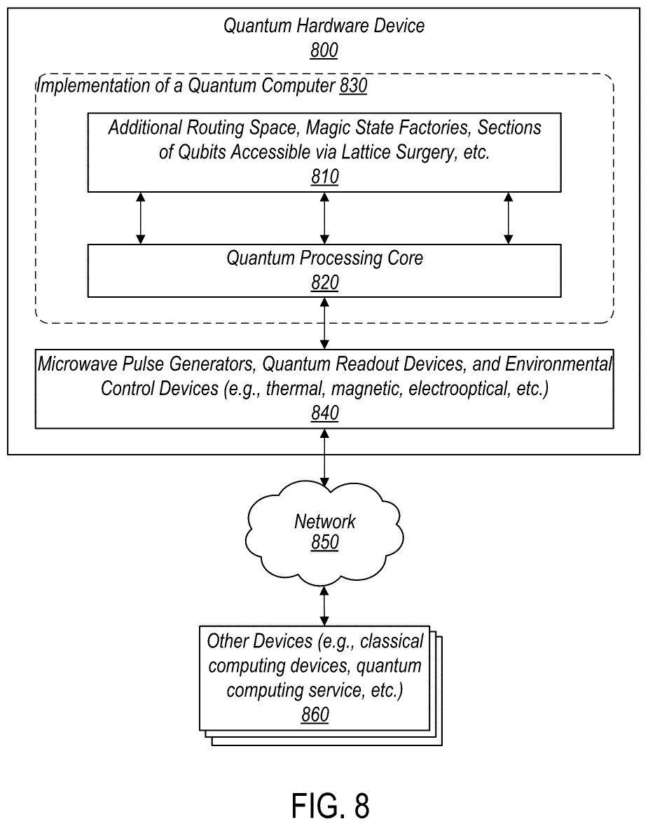

FIG. 8 is a block diagram illustrating an example quantum hardware device that may be configured to execute quantum algorithms used in determining weight pruning choices, according to some embodiments.

As shown in FIG. 8, a quantum hardware device 800 may comprise one or more central quantum processing units (QPUs) and/or quantum processing cores 820 that, collectively, implement a quantum computer 830. Various configurations of physical qubits may be included in implementation of quantum computer 830 wherein a given subset of a total number of qubits may represent quantum processing core 820 and another given subset of qubits may be used to implement magic state factories, additional routing space, and/or additional quantum processing cores that are accessible via lattice surgery, as shown in block 810. Portions of quantum computations and/or operations may be performed in quantum processing core 820, wherein computationally intensive logical computations may use magic state factories within block 810 in order to produce magic states that may be used to store intermediate computations such that they are held in memory during such quantum computations. In some embodiments, a given magic state factory of block 810 may be merged with quantum processing core 820 during a procedure such as lattice surgery in order for information to pass between such components of the quantum computer.

As related to the description herein, one or more superconducting and/or bosonic qubits within implementation of quantum computer 830 may additionally be coupled to a quantum readout device for measurements of quantum information following performance of one or more quantum gates, such as two-qubit entangling gates described herein. The given quantum readout device may be locally connected to various qubits of quantum processing core 820, as shown by interaction arrows to/from block 840.

Depending upon factors such as type(s) of qubit technologies used (e.g., superconducting architectures, bosonic architectures, joint architectures, etc.), type(s) of gates performed between said qubits (e.g., entangling gates, readout measurements), etc., quantum hardware device 800 may also comprise various control devices (e.g., microwave pulse generators, lasers, devices for temperature, magnetic, and/or other environmental controls pertaining to local environments of the grid of qubits within implementation of quantum computer 830, etc.) that may be used to maintain and/or transform various properties of the qubits and/or other physical components of a given quantum computer, as shown via local environmental control devices within block 840. For example, a microwave pulse generator may be locally coupled to one or more quantum hardware components within quantum processing core 820 (e.g., to tunable coupler 110), such that a microwave pulse emitted from the microwave pulse generator may be used to initiate and terminate a microwave-activated, two-qubit entangling gate between various qubits of quantum processing core 820.

In some embodiments in which local environmental control devices 840 include a processor such as processors 910, local environmental control devices 840 may additionally be configured to interact with other devices 860 via network 850. In some embodiments, other devices 860 may include classical computing devices such as classical computing device 900, which may be configured to interact with quantum hardware device 800 either locally or remotely.

### Illustrative Computer System

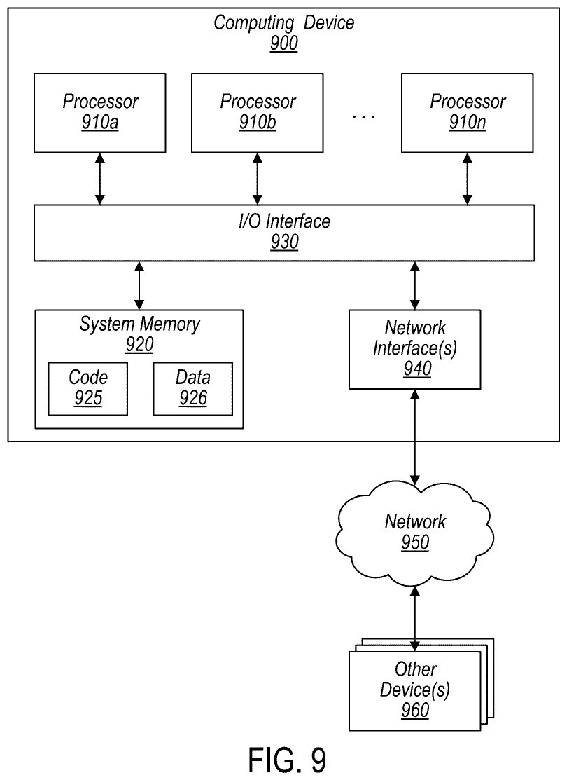

FIG. 9 is a block diagram illustrating an example classical computing device that may be used in at least some embodiments.

FIG. 9 illustrates such a general-purpose classical computing device 900 as may be used in any of the embodiments described herein. In the illustrated embodiment, classical computing device 900 includes one or more processors 910 coupled to a system memory 920 (which may comprise both non-volatile and volatile memory modules) via an input/output (I/O) interface 930. Classical computing device 900 further includes a network interface 940 coupled to I/O interface 930.

In various embodiments, classical computing device 900 may be a uniprocessor system including one processor 910, or a multiprocessor system including several processors 910 (e.g., two, four, eight, or another suitable number). Processors 910 may be any suitable processors capable of executing instructions. For example, in various embodiments, processors 910 may be general-purpose or embedded processors implementing any of a variety of instruction set architectures (ISAs), such as the x86, PowerPC, SPARC, or MIPS ISAs, or any other suitable ISA. In multiprocessor systems, each of processors 910 may commonly, but not necessarily, implement the same ISA. In some implementations, graphics processing units (GPUs) may be used instead of, or in addition to, conventional processors.

System memory 920 may be configured to store instructions and data accessible by processor(s) 910. In at least some embodiments, the system memory 920 may comprise both volatile and non-volatile portions; in other embodiments, only volatile memory may be used. In various embodiments, the volatile portion of system memory 920 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 920 as code 925 and data 926.

In some embodiments, I/O interface 930 may be configured to coordinate I/O traffic between processor 910, system memory 920, and any peripheral devices in the device, including network interface 940 or other peripheral interfaces such as various types of persistent and/or volatile storage devices. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between classical computing device 900 and other devices 960 attached to a network or networks 950, such as other computer systems or devices as illustrated in FIG. 1 through FIG. 8, for example. In various embodiments, network interface 940 may support communication via any suitable wired or wireless general data networks, such as types of Ethernet network, for example. Additionally, network interface 940 may support communication via telecommunications/telephony networks such as analog voice networks or digital fiber communications networks, via storage area networks such as Fibre Channel SANs, or via any other suitable type of network and/or protocol.

In some embodiments, system memory 920 may represent one embodiment of a computer-accessible medium configured to store at least a subset of program instructions and data used for implementing the methods and apparatus discussed in the context of FIG. 1 through FIG. 8. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to classical computing device 900 via I/O interface 930. A non-transitory computer-accessible storage medium may also include any volatile or non-volatile media such as RAM (e.g., SDRAM, DDR SDRAM, RDRAM, SRAM, etc.), ROM, etc., that may be included in some embodiments of classical computing device 900 as system memory 920 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 940. Portions or all of multiple classical computing devices such as that illustrated in FIG. 9 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “classical computing device”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first item could be termed a second item, and, similarly, a second item could be termed a first item, without departing from the scope of the present invention. The first item and the second item are both items, but they are not the same item.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more computing devices configured to implement a machine learning model pruning system, wherein the machine learning model pruning system is configured to:
perform a first pruning pass of a machine learning model wherein at least a portion of the weights are set to zero;
perform one or more additional pruning passes of the machine learning model for one or more respective batches wherein each batch comprises one or more remaining weights and one or more previously pruned weights; and
wherein, performing the one or more pruning passes comprises determining, using an optimization problem, one or more pruning adjustments for a given batch, wherein:
the pruning adjustment comprises restoring a previously pruned weight or pruning a remaining weight of the model; and
wherein the optimization problem is used to find the one or more pruning adjustments for a given batch that substantially minimizes an expected change in value of a loss function for the machine learning model.

2. The system of claim 1, wherein the machine learning model pruning system is configured to:
assign a weight-scoring metric to respective weights of the machine learning model;
prune, during the first pruning pass, respective ones of the weights with a weight-scoring metric below a threshold.

3. The system of claim 1, wherein to perform the first pruning pass:
the portion of the weights that are kept corresponds to a target density, wherein the target density corresponds to a target ratio of:
a number of weights of the machine learning model that have been kept; and
a total number of weights of the machine learning model before the machine learning model is pruned.

4. The system of claim 1, wherein:
the pruning adjustments for a given batch of the one or more additional pruning passes maintains a number of weights not zeroed out after the pruning adjustment to a number of weights not zeroed out before the pruning adjustment within a tolerated range.

5. The system of claim 1, wherein to determine the one or more pruning adjustments, the machine learning model pruning system is further configured to:
exempt weights from consideration for pruning adjustments based on the exempted weights having at least one of:
a determined predicted significance greater than a threshold;
the determined predicted significance less than another threshold; or
been considered for pruning adjustment in a previous batch of a given layer of the machine learning model.

6. The system of claim 1 further comprising:
one or more computing devices configured to implement an optimization problem service, wherein the one or more computing devices that implement the machine learning model pruning system are configured to:
provide the optimization problem to the optimization problem service; and
receive results of the optimization problem from the optimization problem service.

7. The system of claim 6, wherein:
the optimization problem service comprises one or more quantum computing devices; and
the optimization problem is solved using one or more quantum algorithms executed on the one or more quantum computing devices.

8. The system of claim 6, wherein the optimization solver is configured to:
determine estimated gradients for samples of a batch and estimating a mean gradient based on the estimated gradients of the samples; and
estimate a Hessian of the loss function based on the estimated gradients of the samples.

9. A method comprising:
performing a first pruning pass of a machine learning model wherein at least a portion of the weights are set to zero;
performing one or more additional pruning passes of the machine learning model for one or more respective batches wherein each batch comprises one or more remaining weights and one or more previously pruned weights; and
wherein said performing the one or more additional pruning passes comprises determining, using an optimization problem, one or more pruning adjustments for a given batch.

10. The method of claim 9, wherein performing the one or more additional pruning passes comprises:
finding, by substantially solving the optimization problem, the one or more pruning adjustments for a given batch that minimizes an expected change to a loss function;
wherein the one or more pruning adjustments comprises restoring a previously pruned weight or pruning a remaining weight of the model.

11. The method of claim 9, further comprising:
assigning a weight-scoring metric to each weight of the machine learning model;
pruning, during the first pruning pass, respective weights with a weight-scoring metric below a threshold.

12. The method of claim 9, wherein to perform the first pruning pass:
the portion of the weights that are kept corresponds to a target density, wherein the target density corresponds to a target ratio of:
a number of weights of the machine learning model that have been kept; and
a total number of weights of the machine learning model before the machine learning model is pruned.

13. The method of claim 9, wherein said determining the one or more pruning adjustments for a given batch comprises:
maintaining a number of weights after the pruning adjustment to a number of weights before the pruning adjustment within a tolerated range.

14. The method of claim 9, wherein determining the one or more pruning adjustments comprises:
exempting weights from consideration for pruning adjustments based on the exempted weights having at least one of:
a determined predicted significance greater than a threshold;
the determined predicted significance less than another threshold; or
been considered for pruning adjustment in a previous batch of a given layer of the machine learning model.

15. The method of claim 14, wherein determining the one or more pruning adjustments further comprises:
reconsidering weights for pruning adjustment that previously have been exempted from consideration for pruning adjustments, wherein:
the maximum number of exempted weights exempted from consideration for pruning adjustments is a fixed size; and
to reconsider weights for pruning adjustments, other weights are exempted from consideration.

16. The method of claim 9 wherein performing the one or more additional pruning passes comprises:
substantially solving the optimization problem using one or more computing devices configured to implement an optimization solver to determine one or more pruning adjustments for a given batch.

17. The method of claim 16, wherein:
substantially solving the optimization problem is performed by the one or more computing devices that are quantum computing devices; and
substantially solving the optimization problem is performed using one or more quantum algorithms executed on the one or more quantum computing devices.

18. One or more non-transitory computer-readable storage media storing program instructions that, when executed on or across one or more processors, cause the one or more processors to:
perform a first pruning pass of a machine learning model wherein at least a portion of the weights are set to zero;
perform one or more additional pruning passes of the machine learning model for one or more respective batches wherein each batch comprises one or more remaining weights and one or more previously pruned weights; and
determine, using an optimization problem, one or more pruning adjustments for a given batch, wherein:
the pruning adjustment comprises restoring a previously pruned weight or pruning a remaining weight of the model; and
wherein the optimization problem finds the one or more pruning adjustments for a given batch that substantially minimizes an expected change in a loss function.

19. The one or more non-transitory computer-readable storage media of claim 18, wherein the program instructions, when executed on or across the one or more processors, cause the one or more processors to:
maintain a number of weights not zeroed out after the pruning adjustment to a number of weights not zeroed out before the pruning adjustment within a tolerated range.

20. The one or more non-transitory computer-readable storage media of claim 18, wherein the program instructions, when executed on or across the one or more processors, cause the one or more processors to:
exempt weights from consideration for pruning adjustments based on the exempted weights having at least one of:
a determined predicted significance greater than a threshold;
the determined predicted significance less than another threshold; or
been considered for pruning adjustment in a previous batch of a given layer of the machine learning model.
